(19) United States
(12) Patent Application Publication
(10) Pub. No.: US 2016/0036927 A1
(43) Pub. Date: Feb. 4, 2016

(54) DATA PROCESSING SYSTEMS AND METHODS

(71) Applicant: Pierbridge Limited, Yorkshire (GB)

(72) Inventors: Mark Frank NEWBURN, Bedale (GB); Saana Pauliina LIIMATAINEN, Hull (GB)

(21) Appl. No.: 14/813,488

(22) Filed: Jul. 30, 2015

Related U.S. Application Data
(60) Provisional application No. 62/030,733, filed on Jul. 30, 2014.

(30) Foreign Application Priority Data
Jul. 30, 2014 (GB) 1413508.1

(51) Int. Cl. H04L 29/08; H04L 29/06

(52) U.S. Cl. CPC H04L 67/16; H04L 67/02; H04L 63/10

(57) ABSTRACT

Embodiments of the present invention relate to data processing systems and methods for supporting data source integration, such as, for example, real-time web-site modification within a preserved security 5 context by using a substitute an IP address of a desired resource to redirect a request for that resource to a proxy that can provide any such integration.

### RELATED APPLICATION DATA

This application claims the benefit of and priority under 35 U.S.C. §119(e) to U.S. Patent Application No. 62/030,733, filed Jul. 30, 2014, entitled “Data Processing Systems and Methods,” which is incorporated herein by reference in its entirety.

### SUMMARY

Embodiments of the present invention relate to data processing systems and methods.

Software as a Service (SaaS) solutions are an increasingly popular alternative to on-premise enterprise software deployments. SaaS has a number of advantages such as providing information technology (IT) services solutions and infrastructure in a cost effective and relatively swift manner. Furthermore, they allow businesses to concentrate their efforts on more strategic aspects of a business' IT needs.

However, SaaS solutions do not easily integrate well with a business' incumbent enterprise information systems. Integration raises very significant security and data validation issues, in particular, secure browsing environments often inhibit integration efforts.

Embodiments of the present invention address one or more of the above problems.

Accordingly, embodiments of the present invention provide a data processing method, the method comprising commissioning a machine comprising a browser, the browser representing or having a secure environment for at least one of controlling or preventing access to local data, to associate a first universal resource indicator, or protocol data, with an application for accessing the local data accessible to, or stored by, the machine such that invoking the first universal resource indicator executes the application, which can be a protocol data handler; the local data being accessible, or stored externally to, the secure environment.

Furthermore, embodiments provide a data processing method for a machine comprising means to access or store local data and further comprising a browser, the browser representing or having a secure environment for at least one of controlling or preventing access to local data, means to associate a first universal resource indicator, or protocol data, with an application for accessing the local data accessible to, or stored by, the machine such that invoking the first universal resource indicator executes the application, which can be a protocol data handler; the local data being accessible to, or stored externally to the secure environment, the method comprising:
receiving via a browser the first URI, the first URI being associated with a web-application accessible via a server;
retrieving the web-application and accessing supplementary data for supplementing the web-application;
rendering the retrieved web-application augmented by the retrieved supplementary data;
accessing, in response to an invocation associated with the rendered supplementary data, the local data, and
processing the accessed local data with the web-application.

Advantageously, embodiments provide a web-services integration platform to seamlessly integrate disparate data sources, especially with one or more than one web-application. Suitably, any such integration of or local access to local data can be achieved without compromising security or at least without having a browser that is used for any such integration raising security exceptions or failing work as intended due to such security exceptions.

Embodiments are provided in which the server, or other resource repository, comprises at least one of a third party server, a third party application, an enterprise's server, an enterprise's own application running locally or remotely, taken jointly and severally in any and all permutations.

Still further, embodiments provide methods for integrating at least one of data, preferably local data or locally accessible data, and/or services into a web-page from one or more than one source without falling foul of access restrictions such as those imposed by a restricted or constrained computing or browsing environment.

Embodiments provide methods for augmenting web-site content, within a platform for integrating data, such as local data or locally accessible data, into SaaS solutions.

It will be appreciated that the computing environment for the embodiments are preferably established in advance. Therefore, embodiments provide for commissioning such an environment comprising a data processing method, the method comprising commissioning a machine comprising a browser, the browser representing or having a secure environment for controlling access to local data, to associate a first universal resource indicator, or protocol data, with an application for accessing the local data accessible to, or stored by, the machine such that invoking the first universal resource indicator executes the application; the local data being accessible to, or stored externally to, the secure environment.

Suitably, the client machine will have been configured to take appropriate action when encountering a modified or augmented web-page.

Embodiments are provided in wherein the application is configured to facilitate populating a retrieved resource or web-application, associated with a second URI, running via the browser within the secure environment, with the local data.

Furthermore, embodiments are provided wherein the application is configured to facilitate populating the retrieved resource or a web-application, running via the browser within the secure environment, with at least one of address data of the local data or measurement data.

Preferably, embodiments provide a web-application processor configured to process a request for access to a second URI comprising retrieving the retrieved resource or web-application associated with the second URI, retrieving supplementary data associated with the second URI and integrating the retrieved supplementary date into the retrieved resource or web-application; the first URI being associated with the supplementary data.

The supplementary data associated with the second URI may comprise at least an application modifying the functionality of the retrieved resource or web application.

Commissioning the client machine in advance to respond to the first URI is preferable. Suitably, embodiments provide a method further comprising establishing an association between the first URI and the application within an operating system of the machine.

Having suitably commissioned or otherwise provisioned a client machine, embodiments provide a data processing method for a machine comprising a storage manager, to access or store local data, and further comprising a browser, the browser representing or having a secure computing environment for at least controlling access to the local data, a registry to associate a first universal resource indicator, or protocol data, with an application for accessing the local data accessible to, or stored by, the machine such that invoking the first universal resource indicator executes the application; the local data being accessible to, or stored externally to, the secure environment, the method comprising: receiving via a browser the first URI, the first URI being associated with a resource or web-application accessible via a server; retrieving the resource or web-application and accessing supplementary data for supplementing the resource or web-application; rendering the retrieved resource or web-application augmented by the retrieved supplementary data; accessing, in response to an invocation associated with the rendered supplementary data, the local data, and processing the accessed local data with the web-application.

Advantageously, encountering the first URI within the retrieved resource, such as, for example, the web application, embodiments of the present invention facilitate accessing local data notwithstanding a browser's security context.

Embodiments are provided wherein the application is configured to facilitate populating the retrieved resource or the web-application, associated with a second URI, running via the browser within the secure computing environment, with the local data.

Furthermore, embodiments are provided wherein the application is configured to facilitate populating the retrieved resource or the a web-application, running via the browser within the secure computing environment, with at least one of address data of the local data or local data associated with a locally accessible device.

In preferred embodiments, a web-application processor is configured to process a request for access to a second URI, the web-application processor being arranged to retrieve a web-application associated with the second URI, retrieve supplementary data associated with the second URI and integrate the retrieved supplementary date into the retrieved resource or web application; the first URI being associated with the supplementary data.

Preferably, such supplementary data associated with the second URI comprises at least an application modifying the functionality of the retrieved resource or web application.

Embodiments of the present invention can be implemented on a conventional computer suitably programmed to implement the methods, process and/or operations described herein. One or more than one processor, together with software or other code, can be used to realise a data processing system comprising means to implement a method as claimed or described herein.

Having commissioned or otherwise provisioned a client machine, embodiments provide a data processing system comprising a machine comprising a browser, the browser representing or having a secure environment for controlling access to local data, the machine further comprising a processor adapted to associate a first universal resource indicator, or protocol data, with an application for accessing the local data accessible to, or stored by, the machine such that invoking the first universal resource indicator executes the application; the local data being accessible to, or stored externally to, the secure environment.

Embodiments provide a system wherein the application is configured to facilitate populating a retrieved resource or web-application, associated with a second URI, running via the browser within the secure environment, with the local data.

Examples of local data can be address data or measurement data, or any other type of local data associated with a local data source. Suitably, embodiments provide a system wherein the application is configured to facilitate populating the retrieved resource or a web-application, running via the browser within the secure environment, with at least one of address data of the local data or measurement data.

Preferably, embodiments provide a web-application processor configured to process a request for access to a second URI comprising retrieving the retrieved resource or web-application associated with the second URI, retrieving supplementary data associated with the second URI and integrating the retrieved supplementary date into the retrieved resource or web-application; the first URI being associated with the supplementary data. In preferred embodiments, the system supplementary data associated with the second URI comprises at least an application modifying the functionality of the retrieved resource or web application.

Embodiments provide a system further comprising a registry to establish an association between the first URI and the application within an operating system of the machine.

Embodiments provide a data processing system for a machine comprising a storage manager, to access or store local data, and further comprising a browser, the browser representing or having a secure computing environment for at least controlling access to the local data, a registry to associate a first universal resource indicator, or protocol data, with an application for accessing the local data accessible to, or stored by, the machine such that invoking the first universal resource indicator executes the application; the local data being accessible to, or stored externally to, the secure environment, the system comprising a processor adapted to: receive via a browser the first URI, the first URI being associated with a resource or web-application accessible via a server; retrieve the resource or web-application and accessing supplementary data for supplementing the resource or web-application; render the retrieved resource or web-application augmented by the retrieved supplementary data; access, in response to an invocation associated with the rendered supplementary data, the local data, and process the accessed local data with the web-application.

Embodiments are provided wherein the application is configured to facilitate populating the retrieved resource or the web-application, associated with a second URI, running via the browser within the secure computing environment, with the local data.

Embodiments are provided wherein the application is configured to facilitate populating the retrieved resource or the a web-application, running via the browser within the secure computing environment, with at least one of address data of the local data or local data associated with a locally accessible device.

Preferred embodiment provide a web-application processor configured to process a request for access to a second URI, the web-application processor being arranged to: retrieve a web-application associated with the second URI, retrieve supplementary data associated with the second URI and integrate the retrieved supplementary date into the retrieved resource or web application; the first URI being associated with the supplementary data.

Embodiments provide a system wherein the supplementary data associated with the second URI comprises at least an application modifying the functionality of the retrieved resource or web application.

### BRIEF DESCRIPTION OF THE FIGURES

Embodiments of the invention are further described herein, by way of example, with reference to the accompanying drawings, in which:

FIG. 1 shows a prior art data processing system;

FIGS. 2 and 2A illustrate data processing systems according to embodiments;

FIG. 3 depicts a data flow of data processing systems according to embodiments;

FIG. 4 shows a further data processing system according to an embodiment;

FIG. 5 illustrates a data flow of the further data processing system according to an embodiment;

FIG. 6 shows a first view of a rendered unmodified web-page, that is pre-enrichment;

FIG. 7 illustrates a second view of the rendered modified web-page, that is, post-enrichment;

FIG. 8 depicts a third view of the rendered modified web-page showing access to local data; and

FIG. 9 shows a fourth view of the rendered modified web-page populated with local data.

### DETAILED DESCRIPTION

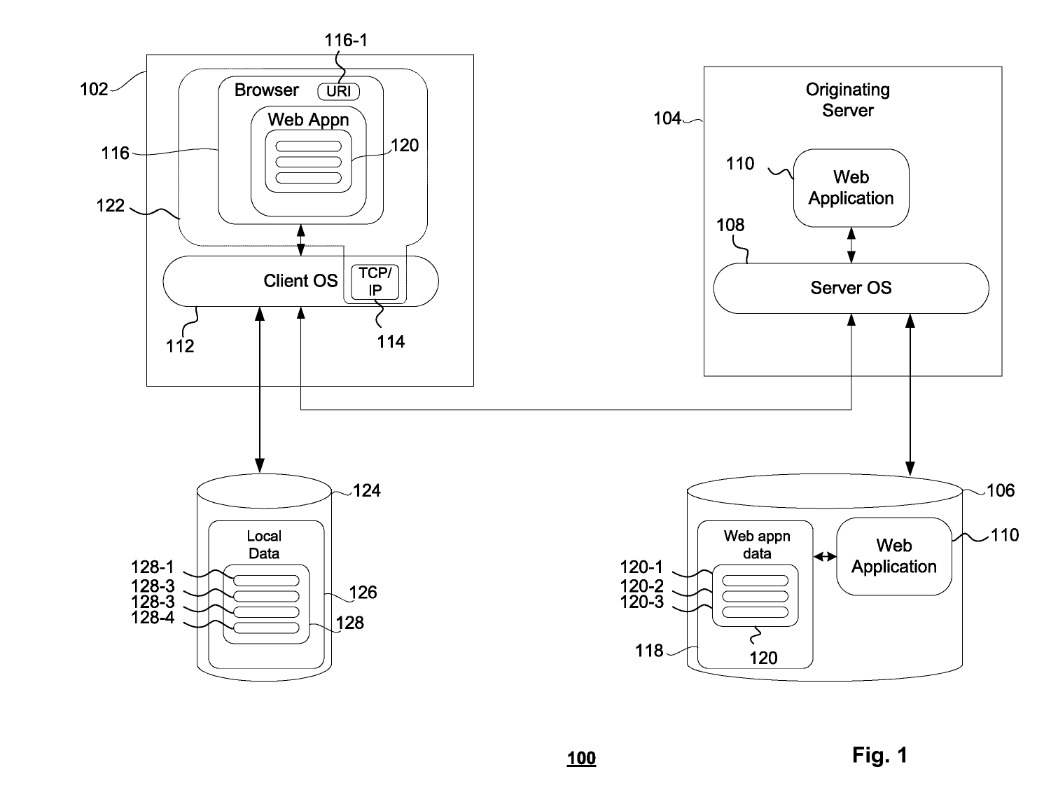

Referring to FIG. 1, there is shown a view 100 of a prior art data processing system 102, a client machine, interacting with a server 104 under a conventional client-server relationship. The server 104 comprises machine accessible storage 106. The storage can be a non-volatile medium such as, for example, an HDD, or another machine that is part of a plurality of machines providing a server farm. The server 104 runs a server operating system 108, which can be any server OS such as, for example, a Linux server operating system such as Red Hat Enterprise Linux or a Windows server operating system such as Windows Server Enterprise 2008. The server operating system 108 is arranged to meet requests for a resource, specified as, or accessible via, a URI or URL, such as, for example, a web-application 110, or other web-content.

The server operating system 108 accesses and outputs the retrieved resource, such as the web-application 110, to the client machine 102 for execution or rendering. The client machine 102 comprises a respective operating system 112 that can communicate with the server's operating system 108. The communication can be supported using, for example, a TCP/IP protocol stack 114 or some other protocol. In particular, the client machine 102 comprises a browser 116 that is used to access resources via the Internet such as, for example, the web-application 110. The web-application 110 is retrieved, or accessed, using a respective first URI 116-1, and rendered or otherwise executed or processed, by the web-browser 116.

In the instant example, the web-application 110 collects or generates associated web application data 118. The web-application data 118 can be any data such as data element 120. At least one of the web-application data 118 and the data element 120 can comprise multiple aspects or multiple fields. In the present example, the data element 120 comprises multiple fields, in particular, first 120-1 to third 120-3 fields. The data element can represent, for example, an address record and the fields 120-1 to 120-3 can represent the address lines of an address.

A user of the browser 116 can enter the web-application data 118 as part of an interaction with the web-application 110 within the browser. It should be noted that the web-application data is stored within the server's storage 106. Furthermore, one skilled in the art will appreciate that the browser 116 and web-application 110 execute or otherwise operate or have influence within a restricted or secure environment 122. The restricted or secure environment 122 controls or limits the extent to which at least one of the browser 116 and, in particular, the retrieved resource, such as the web-application 110, can interact with any other aspect of the client machine 102. An example of such a restricted or secure environment is provided by a browser security model or policy, which imposed restrictions regarding operations or other activities that can be performed by the browser such as, for example, executing an application, executing a script outside of the browser's environment or accessing local data, taken jointly or severally.

It will be appreciated that the client machine 102 comprises, or at least has access to, storage 124. The storage 124 can comprise, for example, non-volatile storage in the form of a solid state drive, an HDD or other form of non-volatile storage. The storage 124 is arranged to store local data 126.

Local data is data that is, or can be, stored externally to the restricted environment 122. It will be appreciated that, but for embodiments of the present invention, such local data is inaccessible from within the secure computing.

It can be appreciated that the local data, which might be locally stored address data, cannot be used or accessed and cannot, therefore, be integrated with the web-application or other web-accessible resources or content, but for embodiments of the present invention.

Therefore, even though a user might already have an extensive data base of local data, such as, for example, a data base of addresses, integrating that local data with a web-application is prohibited due to the web-application being operable within the restricted or secure computing environment and the local data being disposed external to that restricted environment. A user would have to manually integrate the local data with the web-application, which is clearly undesirable and time consuming.

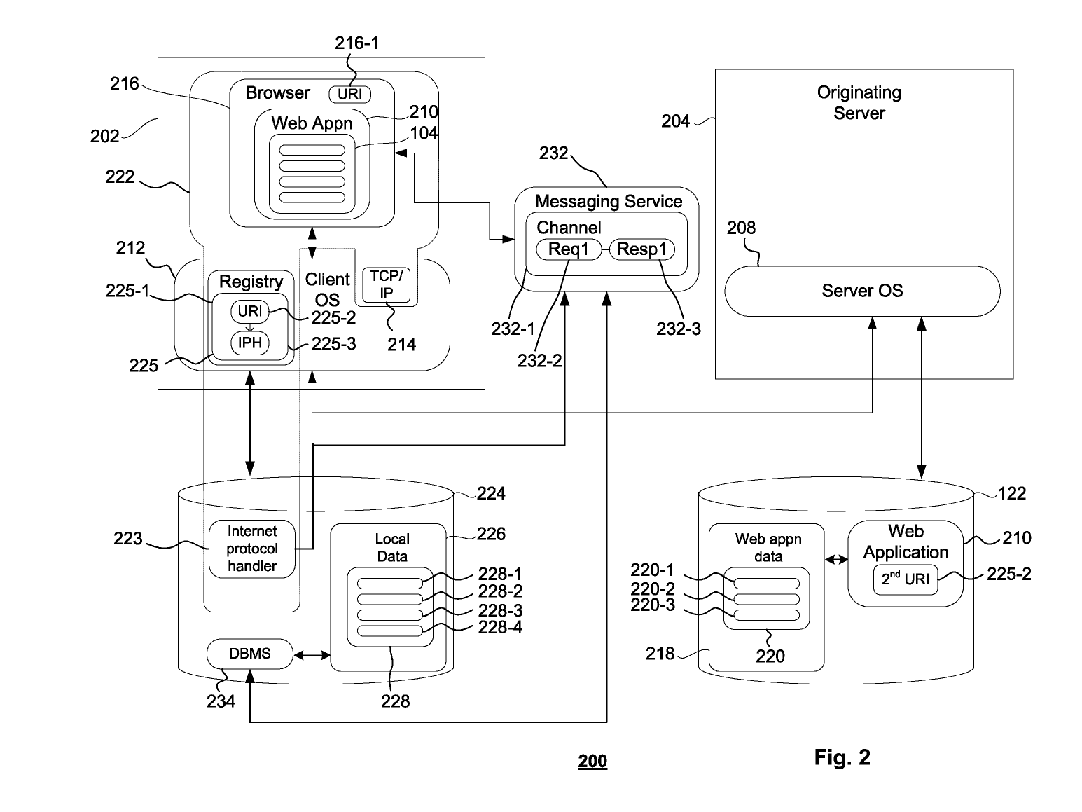

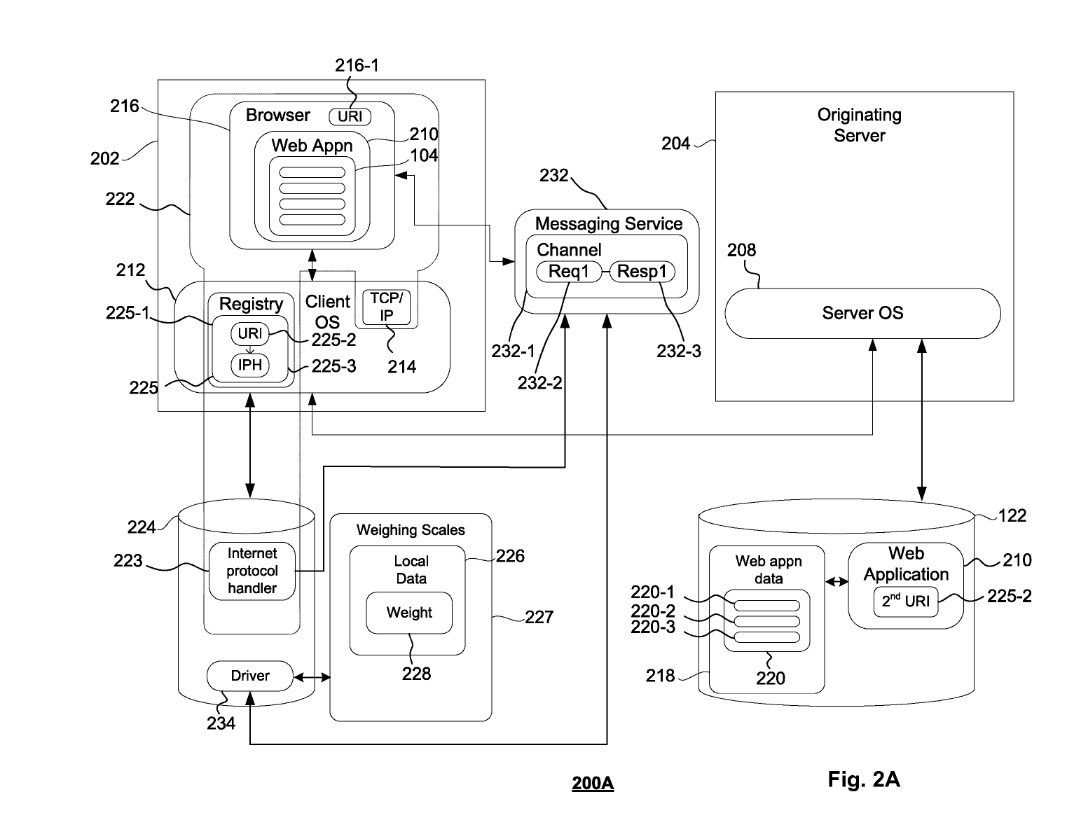

FIG. 2 illustrates a view 200 comprising a data processing system 202 according to an embodiment, that is, a client machine, interacting with a conventional server 204 under a conventional client-server relationship. The server 204 comprises machine accessible storage 206. The storage 206 can be a non-volatile medium such as, for example, an HDD, or another machine that is part of a plurality of machines providing a server farm. The server 204 runs a server operating system 208′ which can be any server OS such as, for example, a Linux server operating system such as Red Hat Enterprise Linux or a Windows server operating system such as Windows Server Enterprise 2008. The server operating system 208 is arranged to meet requests for one or more than one resource, specified as a URI or URL, such as, for example, a web-application 210 or other web accessible content.

The server operating system 208 accesses and outputs the web-application to the client machine 202 for execution or rendering. The client machine 202 comprises a respective operating system 212 that can communicate with the server's operating system 208. The communication can be supported using, for example, a TCP/IP protocol stack 214 or some other protocol. In particular, the client machine 202 comprises a browser 216 that is used to access resources via the Internet; resources such as, for example, the above one or more than one resource like the web-application 210. The web-application 210 is retrieved, using a respective first URI 216-1, and rendered, or otherwise executed, by the web-browser 216.

As with the web-application 110 described above, in the instant example, the web-application 210 can collect, generate or is otherwise operable with associated web application data 218. The web-application data 218 can be any data such as data element 220. At least one of the web-application data 218 and the data element 220 can comprise multiple aspects or multiple fields. In the present example, data element 220 comprises multiple fields, in particular, first 220-1 to third 220-3 fields. The data element 220 can represent, for example, an address record and the fields 220-1 to 220-3 can represent the address lines of the address.

A user of the browser 216 can enter the web-application data 118 as part of an interaction with the web-application 210 within the browser. However, as indicated above, that is time consuming and inefficient, especially when the data being or to be entered already exists.

Furthermore, one skilled in the art will appreciate that the browser 216 and web-application 210 execute, otherwise operate or have influence, within a restricted or secure computing environment 222. The restricted or secure computing environment 222 controls or limits the extent to which at least one of the browser 216 and, in particular, the web-application 210 can interact with any other aspect of the client machine 202. An example of such a restricted or secure computing environment is given above.

Therefore, the client machine 202 is commissioned with an internet protocol handler or comparable application 223. The internet protocol application 223 is an executable application that is executed in response to the browser 216 processing a specified universal resource indicator associated with that handler. The universal resource indicator can be the first URI 216-1. Alternatively, or additionally, the universal resource indicator that launches the internet protocol handler can be a second URI that is different to the first URI 216-1 or a second URI that is associated with the first URI.

The internet protocol application 223 is registered within a registry 225. The registry, within the context of a Windows operating system available from Microsoft Corporation, is modified to contain an entry 225-1 that relates a given URI 225-2, such as the first URI 216-1, with a respective internet protocol handler 225-3 such as the internet protocol handler 223. For example, within a Windows operating system context, to register an application to respond to a given URI, that is, to handle a particular URI scheme, a new key, along with appropriate sub-keys and values, are added to HKEY_CLASSES_ROOT. The root key must match the URI scheme that is being added. For instance, to add an “address:” scheme, an address key is added to HKEY_CLASSES_ROOT, as follows:

```
HKEY_CLASSES_ROOT
  Address
  URL Protocol = ″ ″
```

The URL Protocol string value indicates that this key declares a custom pluggable protocol handler 223. One skilled in the art appreciates that internet protocol handler 223 will not launch without the key. The value should be an empty string. It will also be appreciated that respective keys should be added for DefaultIcon and shell. The Default string value of the DefaultIcon key is the file name as the icon for new URI scheme. The string takes the form “path, iconindex” with a maximum length of MAX_PATH. The name of the first key under the shell key is preferably an action verb, such as open. Under the action verb key, a command key or a DDEEXEC key indicates how the internet protocol handler 223 should be invoked. The values under the command and DDEEXEC keys describe how to launch the internet protocol handler 223 for handling the new protocol.

Still further, the Default string value preferably contains the display name of the new URI scheme. Embodiments provide the following key structure for registering the internet protocol handler 223 within the register 225. The internet protocol handler 223 is an executable file with the file name “address.exe”. The following example shows how to register an application, address.exe in this case, to handle the address scheme.

```
HKEY_CLASSES_ROOT
  address
    (Default) = ″URL:Address Protocol″
    URL Protocol = ″ ″
    DefaultIcon
      (Default) = ″address.exe,1″
    shell
      open
        command
          (Default) = ″C:\Program Files\Address\address.exe″ ″%1″
```

Therefore, when the browser 216 encounters the registered URI, such as, for example, the first URI 216-1, corresponding to the internet protocol handler 223, or when a user invokes a graphical element associated with a link containing, or associated with, the registered URI, the browser 216 launches the internet protocol handler 223 registered for that URI.

Accordingly, when the browser 216 processes a URI, such as the first URI 216-1, that has an entry 225-1 within the registry 225 associating that URI 216-1/225-2 with an IPH 225-3, the operating system 212 executes or launches the internet protocol handler 223.

In preferred embodiments, the internet protocol handler 223 launches, or otherwise provides access to, a messaging service 232. The messaging service is an embodiment of a connector. The messaging service 232 supports data exchange between the retrieved resource, such as the web application 210, and a data base management system 234 that manages the local data 226. It will be appreciated that the data base management system is an embodiment of a storage manager for accessing local storage. It will be appreciated that such local data has been defined above.

It will be appreciated that the client machine 202 comprises or at least has access to storage 224. The storage 224 can comprise, for example, non-volatile storage in the form a solid state drive, an HDD or other form of non-volatile storage. The storage 224 is arranged to store the local data 226, that is, data stored externally to the restricted or secure computing environment 222.

It can be appreciated that the local data can be locally stored address data, which, but for embodiments of the present invention, would otherwise be inaccessible to the web-application, or any other entity within the restricted environment 222, can now be integrated with the retrieved resource, such as the web-application or other web-accessible content, associated with the URI 216-1, via the internet protocol handler 223.

Therefore, a user already having an extensive data base of local data, such as, for example, a data base of addresses, can integrate that local data with the web-application 210 because that local data is rendered accessible by the internet protocol handler 223 and the messaging service 232. The messaging service 232 operates as an intermediary for exchanging data between the web application 210 and the data base management system 234.

According to one embodiment, the messaging service 232 uses a publish/subscribe model. A common identifier or token is associated with the web application 210 and the data base management system 234, that is, the common identifier or token define a channel 232-1 via which the web application 210 and the data base management system 234 can exchange data such as, for example, the local data 226 or any other data. The web application 210 can post or otherwise publish a request 232-2 for access to the local data 226 via the channel 232-1. The data base management system 234 is arranged to listen or otherwise respond to such a request 232-2 by posting or publishing a response 232-3, via the common channel 232-1, that meets the request 232-2.

Although the messaging service 232 has been depicted as being separate to the client machine 202, embodiments are not limited to such an arrangement. The messaging service 232 can be stored locally by the client machine or be otherwise locally accessible to the client machine via, for example, a server. Additionally, or alternatively, the client machine 202 can be stored by the local storage 224 and executable by the client machine 202.

Referring to FIG. 2A, there is shown a view 200A of a data processing system according to a further embodiment. The further embodiment operates substantially as described above with reference to FIG. 2 and like reference numerals refer to corresponding elements. However, it will be appreciated that the messaging service 232 acts as an intermediate between the retrieved resource, such as the web application 210, and local data 226. The local data 226 is associated with, or it otherwise accessible from, a respective device 227. In one embodiment, the device is a local device that can be accessed via a respective interface, such as a USB interface, and driver 234. The messaging service 232 communicates with the driver to access the local data 226 of the device. In a preferred embodiment, the local device is a weighing scale coupled to the client machine or otherwise accessible to the client machine. An instance of the local data preferably contains an indication 228 of a weight associated with a package being weighed by the weighing scales.

As above, the messaging service 232 operates as an intermediary between the web application 210 and the device 227. The web application 210 is operable to publish, via a selected channel 232-1, a request 232-2 for a weight measurement from the weighing scale. The driver 234, or other software, is arranged to listen for such requests 232-2 and to obtain a published a weight measurement 228. The weight measurement 228 can then be read by the web application 210 via the common channel thereby integrating locally accessible data to the remotely retrieved resource, that is, in the present embodiment, the web application 210.

In any and all embodiments, the common channel 232-1 can be either dynamically assigned by, for example, the internet protocol handler 223. Alternatively, or additionally, the common channel can be commissioned in advance, that is web application and the device can be configured to use a pre-assigned common channel.

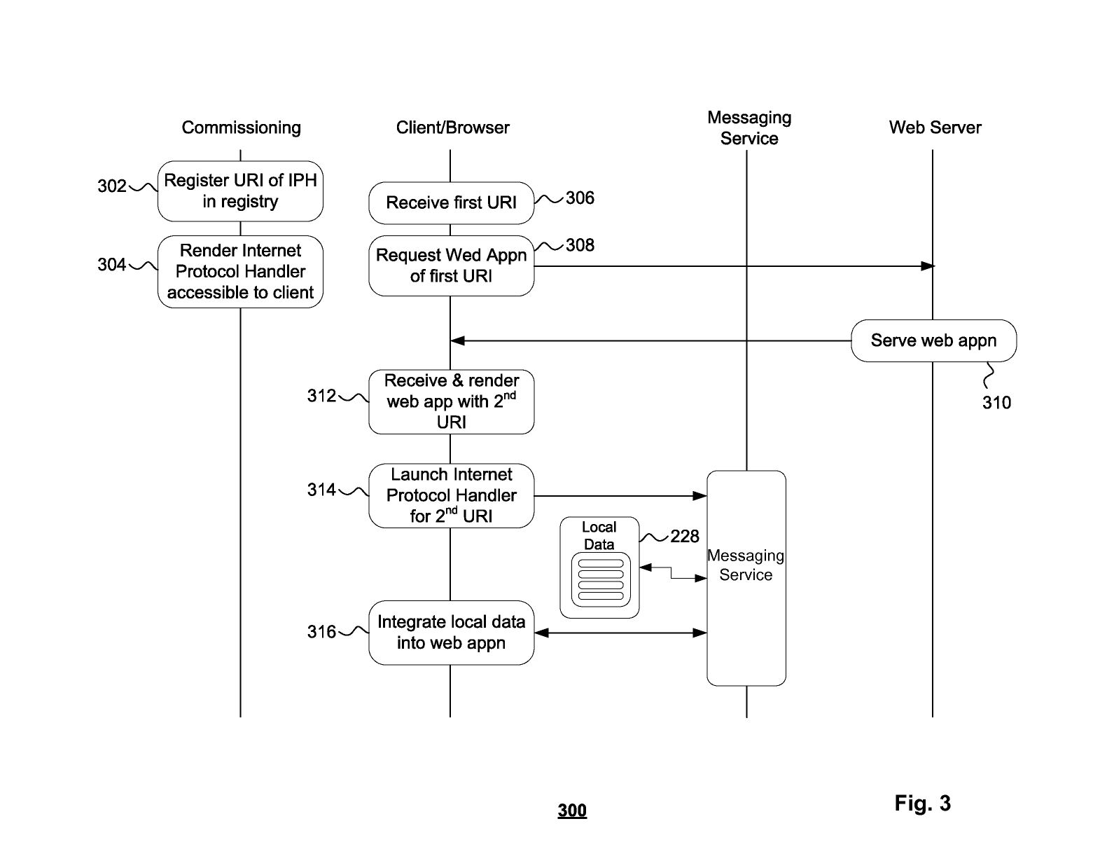

FIG. 3 depicts a view 300 of various data flows of a data processing system according to an embodiment such as, for example, any and all embodiments described herein. At step 302, the registry entry 225 is created, within the registry 225, that associates the first URI 216-1 with the internet protocol handler 223 during a commissioning phase of the client machine 202. The internet protocol handler 223 is made available for launching at step 304. Making the internet protocol handler 223 available for launching comprises storing it within a directory having a path that corresponds to the path identified in the registry entry 225 so that the operating system 212 can locate and launch it.

The processing undertaken by the client machine 202 is depicted in FIG. 3. Assuming that the client machine 202 is already running the browser 216, a first URI is encountered by the browser at step 306. The browser can encounter the first URI in at least one of a number of ways such as, for example, a user entering the first URI into the browser, retrieved web-content containing the first URI that is interpreted or processed by the browser, and retrieved web-content containing a graphical icon that is associated with the first URI. The web-content could comprise the web-application 210 or any other web-content. The web-content could be associated with a third party machine or associated with a machine within the same enterprise or within a related enterprise to the client machine 202.

A request is issued at step 308 for the resource corresponding to the first URI entered at step 306. In the present embodiment, the first URI corresponds to the URI for the web-application 210. The requested is received and responded to by the server 204, which sends, at step 310, the web-application 210 to the browser for processing.

The browser receives, at step 312, the web-application 210 and processes or executes that application 210. In the present embodiment, the web-application 210 contains an instance of a second URI, that is, the URI 225-2 associated with the internet protocol handler 223. Upon encountering or otherwise processing the second URI 225-2, the browser passes the second URI 225-2 for processing by the operating system 212, that, in turn, determines whether or not the registry 225 contains an entry 225-1 corresponding to the second URI 225-2.I In response to noting a match between the second URI 225-2 and the registry entry, the operating system 212 launches the internet protocol handler 223 at step 314. The internet protocol handler 223, in turn, launches the messaging service 232 at step 315 to facilitate data exchange between the retrieved resource and the local data 228, made available via the local data source. As indicated above, the local data source can be further software, such as the data base management system 234 described above or a locally accessible device 227 such as, for example, the weighing scales. The web application 210 can then integrate the local data, such as a weight measurement 228, with the web-application 216 at step 316.

It can be appreciated that the internet protocol handler 223 and/or the messaging service can perform at least one of processing associated with the web-application, interacting with the web-application, integrating local data with web-application, processing web application data 218 taken jointly and severally in any and all permutations.

Any and all embodiments described herein can be realised in which the intermediary or connector acts other than as a messaging service. The intermediary or connector can, from the perspective of the retrieved resource, merely appear as a further local data source. For example, the connector or intermediary 232 can facilitate data exchanges with other software that generates or otherwise outputs data, that can, from the perspective of the retrieved resource appear as local data as defined herein. For example, the device 227 can output an image as local data 228. The image 228 could be an image of a parcel captured by a camera as that parcel progresses through the postal or delivery service.

In the embodiment illustrated, it can be appreciated that the internet protocol handler 314 and the messaging service, that is, connector, integrate the local data 228 of the client machine with the web application 210.

In preferred embodiments, the messaging service 232 accesses the local data using a subscribe/publish model. The retrieved resource 210 subscribes to a particular channel 232-1 published, or otherwise made available, by the commonly accessible intermediary 232, which is also known, more generically, as a connector. The channel 230 makes available to the retrieved resource 210 any data published on that channel 232-1 by the messaging service 232.

The messaging service 232 functions as an intermediary between the web application 210 and at least one of a data base management system 234, or other software, and the weighing scales, or other device. The data base management system 234, or other software, is arranged to subscribe to the same channel 232-1 of the messaging service 232 via which at least one of the data base management system 234, or other software, and weighing scales, or other device, receives requests for local data published or posted by, and/or requested by the web application 223.

A least one of the data base management system 234, or other software, and weighing scales, or other device, is arranged to respond to the requests for local data received via the channel 232-1 by making local data 228 available to the messaging service 232 via the channel 232-1. In turn, the messaging service 232 makes any such published local data available to the web application 210, or other retrieved resource.

The embodiments described herein can be realised such that, additionally or alternatively, the messaging service 232 receives the requests issued by at least one of the data base management system 234, or other software, and the device 227 for data from the retrieved resource 210.

Therefore, data can be exchanged between one or more than one entity within the secure or restricted computing environment and one or more than one entity external to the secure or restricted computing environment.

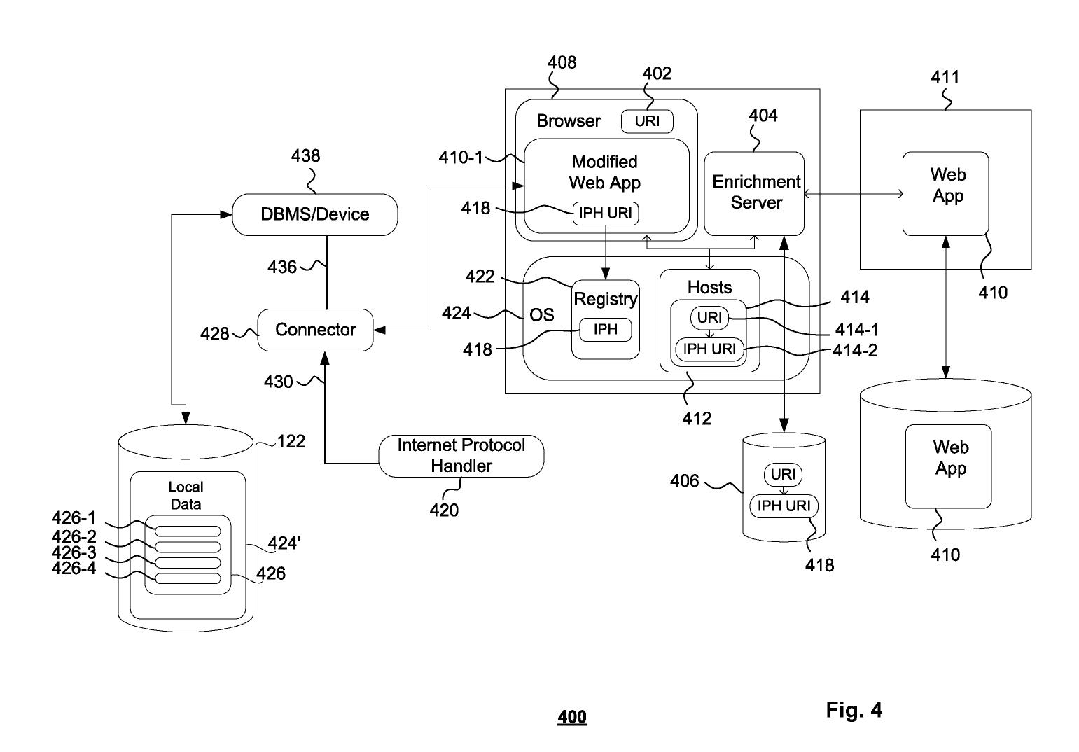

FIG. 4 shows view 400 comprising a further data processing system 402 according to an embodiment. The data processing system 402, or client machine, operates substantially as the client machines 202 described above, but is supplemented with additional functionality in the form of an enrichment server 404. It will be appreciated that the enrichment server is an embodiment of a web application processor. The enrichment server 404 is responsible for processing a URI 406 entered into, or otherwise being associated with, a browser 408 to retrieve the web-content identified by that URI 406. In the illustrated embodiment, the web-content is a web application 410. The web application 410 can be the same as the above described web application 210, stored on a respective server 411.

The client machine 402 is commissioned such that a predetermined file 412 contains an entry 414 that maps a predetermined URI, such as the above URI 406, to an alternative URI 416. Preferably, the predetermined file is a HOSTS file. The alternative URI 416 is arranged to pass the original URI 406 to the enrichment server 404. As indicated above, the enrichment server 404 is arranged to retrieve the resource identified by the URI 406. The enrichment server 404 is also arranged to access a further resource 418. The further resource 418 is associated with the original URI 406 and is intended to supplement any retrieved resource identified by that original URI 406 to create a modified retrieved resource 410-1. Such a system is described in co-pending UK patent application No. GB1403896.2, which is incorporated herein for all purpose and a copy of which forms part of the description of the present application as can be appreciated from the Appendix.

Embodiments can be realised in which the further or supplementary resource 418 is a still further or second URI that is associated with an internet protocol handler 420, such as the internet protocol handler 223 described above. As indicated above, the association between the internet protocol handler 420 and the second URI 418 of the supplementary data or supplementary resource is reflected in the registry 422 of the operating system 424 of the client machine 402.

Invoking or otherwise processing the second URI 418 launches the internet protocol handler or application 420. Any such invoking or processing takes the form of processing the retrieved resources 410 augmented by the further resource 418. In the present embodiment, as with the embodiments described above, the internet protocol handler 420 and a connector 428, which is an embodiment of an intermediary as described above, are arranged to integrate local data with the modified retrieved resource 410-1. The connector 420 is arranged to cooperate with at least one of a data base management system 422, or other software, such as, for example, an SQL server, and local device, such as, for example, the weighing scales, to access local data 424′ stored on a storage medium such as, for example, an HDD or other non-volatile storage or access local data made available by the local device. The local data may comprise one or more than one data element 426. The one or more than one data element 426 may comprise multiple fields or sub-elements. In the embodiment shown, there are four sub-elements or fields 426-1 to 426-4, which, preferably, correspond to fields of an address. Alternatively, or additionally, the local data can, as described in the above embodiments, represent a measurement such as a weight measurement, or other data, such as, for example, an image.

The retrieved resource or modified resource 410-1 is arranged to integrate the local data 424′ using the connector 428, such as any of the above-described messaging services 232. The internet protocol handler 420, the data base management system 422, or other software, and the connector 428 cooperate to integrate the modified retrieved resources 410-1 and the local data 424′.

Embodiments described with reference to FIG. 4, allow a retrieved third party resource, such as, for example, a web application, to be retrieved and augmented with the ability to access and integrate local data, regardless of the source of that local data, with the retrieved third party resource.

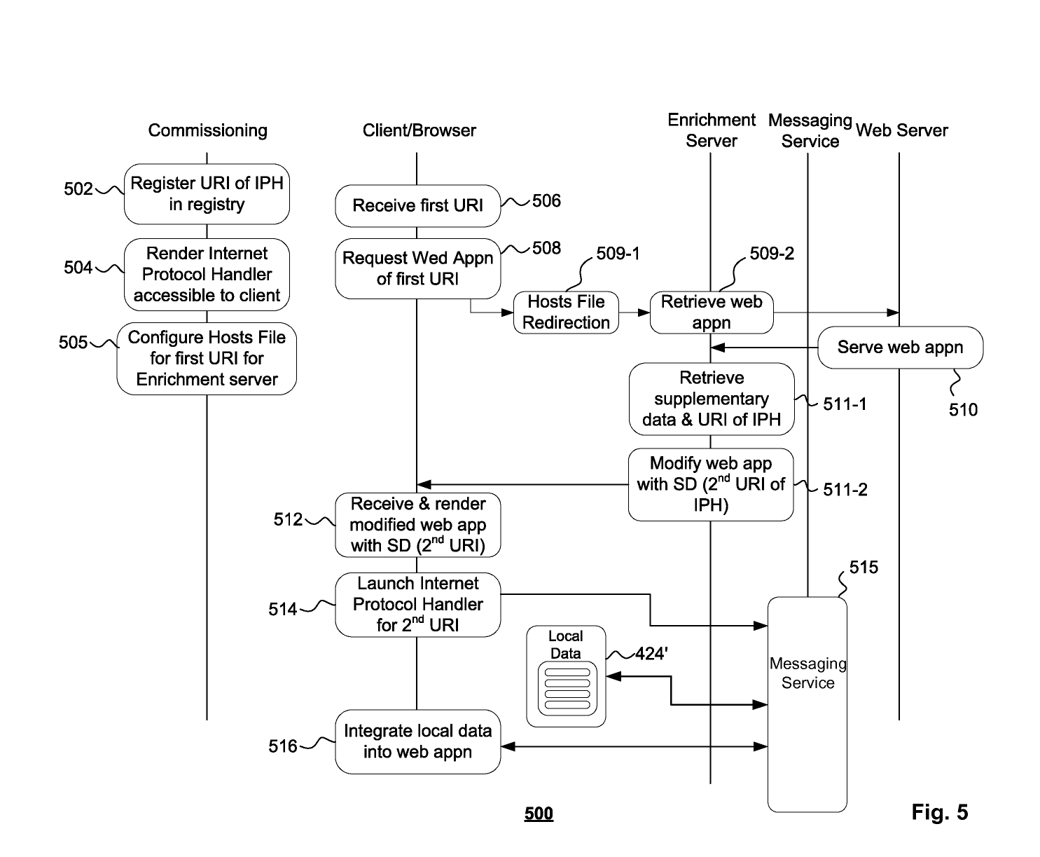

FIG. 5 illustrates a view 500 of data flows associated with a data processing system 402 according to an embodiment. At step 502, the registry entry 418 is created, within the registry 422, that associates the second URI 418 with the internet protocol handler 420 during a commissioning phase of the client machine 402. The internet protocol handler 420 is made available for launching at step 504. Making the internet protocol handler 420 available for launching comprises storing it within a directory having a path that corresponds to the path identified in the registry entry 418 so that the operating system 424 can locate and launch it. The client machine 402 is also provisioned, at step 505, with the hosts file 412 that contains mapping between the first URI 406 and the substitute URI 414-1 of the enrichment server 404.

Assuming that the client machine 402 is already running the browser 408, the first URI 406 is encountered by the browser at step 506. The browser 408 can encounter the first URI 406 in at least one of a number of ways such as, for example, a user entering the first URI 406 into the browser, retrieved web-content containing the first URI 406 that is interpreted or processed by the browser, and retrieved web-content containing a graphical icon that is associated with the first URI 406. The web-content could comprise the web-application 410 or any other web-content. The web-content could be associated with a third party machine or associated with a machine within the same enterprise or within a related enterprise to the client machine 402.

A request is issued at step 508 for the resource corresponding to the first URI 406 entered at step 506. In the present embodiment, the first URI 406 corresponds to the URI of the web-application 410. The request is processed by the operating system 424, which is arranged to substitute the first URI 406 with the URI 414-1 of the enrichment server 404, or otherwise direct the request for the resources identified by the first URI to the enrichment server 404 via the hosts file at step 509-1. The enrichment server 404 receives the request at step 509-2 and requests the resources associated with the first URI 406 from the web server 411 at step 509-2. The request is received and responded to by the server 411, which sends, at step 510, the web-application 410, or other resource, to enrichment server 404 for processing.

The enrichment server 404 receives, at step 511-1, the retrieved resources, in the form of the web application 410 in the illustrated embodiment, and also retrieves a further resource 418, which is the second URI, that is, the URI associated with the internet protocol handler 420, or other means of launching or invoking the internet protocol handler 420. The enrichment server 404, at step 511-2, modifies the retrieved web resource 410 to incorporate the second URI 418, or other means of launching or invoking the internet protocol handler 420, and forwards the modified retrieved web resource 410 to the browser 410-1 for further processing. Furthermore, the further resource 418 also comprises software for modifying the retrieved resource 410 so that it can interact with a messaging service 232, or connector/intermediary, as described above in any and all embodiments described above. The software will assign the common channel 428′ for use in exchanging data, such as the local data 424′, between the retrieved resource 410 and the source of the local data such as, for example, at least one of the data base management system, or other software, and a device, such as, for example, the above described devices.

The browser 410 receives, at step 512, the modified web resource 410 and processes or executes that resource 410. In the present embodiment, the web-application 410 contains an instance of the second URI 418 that is associated with the internet protocol handler 420. Upon encountering or otherwise processing the second URI 418, the browser 410-1 passes the second URI 418 to the operating system 424 for processing or resolving. The operating system 424, in turn, determines whether or not the registry 422 contains an entry corresponding to the second URI 418, and, in response to noting a match between the second URI 418 and the registry entry, launches the respective internet protocol handler 420 at step 514. The internet protocol handler 420, in turn, launches, at step 515, the messaging service 232 or connector 428 to facilitate access to local data 424′ as described above and to facilitate integrating any such local data 424′ with the modified retrieved web resource 410 at step 516.

It can be appreciated that the connector 428 can perform at least one of processing associated with the web-application, interacting with the web-application, integrating local data with web-application, processing web application data and processing local data supplied by or associated with a local data source taken jointly and severally in any and all permutations.

In the embodiment illustrated, it can be appreciated that the connector 428 facilitates integrating the local data 424′ of the client machine 402 with the web application 410 using the publish/subscribe model, or other data exchange model, described above.

In preferred embodiments, the connector 428 facilitates access to the local data 424′ using a subscribe/publish model. The retrieved resource 410 subscribes to a commonly accessible 428′ published, or otherwise made available, by the commonly accessible connector 428. The channel 428 makes available to retrieved resource 410 any data published on that channel 428′ by the connector 428.

The connector 428 functions as an intermediary between the retrieved resource 410 and at least one of the data base management system 422, or other software, and the weighing scales, or other device. At least one of the data base management system 422, or other software, and device is arranged to subscribe to the channel 428′ via requests, published by the web application or other retrieved resource 410, for local data can be received.

At least one of the data base management system 422, or other software, and the device is arranged to respond to the requests for local data received via the channel 428′ by making local data 424′ available to the connector 428 the channel 428′ by publishing the requested local data, via the channel 428′.

The connector 428 receives published local data 424′ and makes that local data available to the retrieved resource 410 via the common channel 428′ to which the retrieved resource subscribes.

Therefore, data can be exchanged between one or more than one entity within the secure or restricted computing environment and one or more than one entity external to or without the secure or restricted computing environment.

In any of the above embodiments, the local resources may have already been generated prior to rendering the retrieved web-content. Alternatively, or additionally, the local data may have been generated by the retrieved web-content and stored locally.

Embodiments of resource enrichment have been described in co-pending application GB1403896.2, the content of which is incorporated herein for all purposes and whose right of priority is hereby claimed. A copy of GB1403896.2 forming part of the description of the present application is given in the appendix.

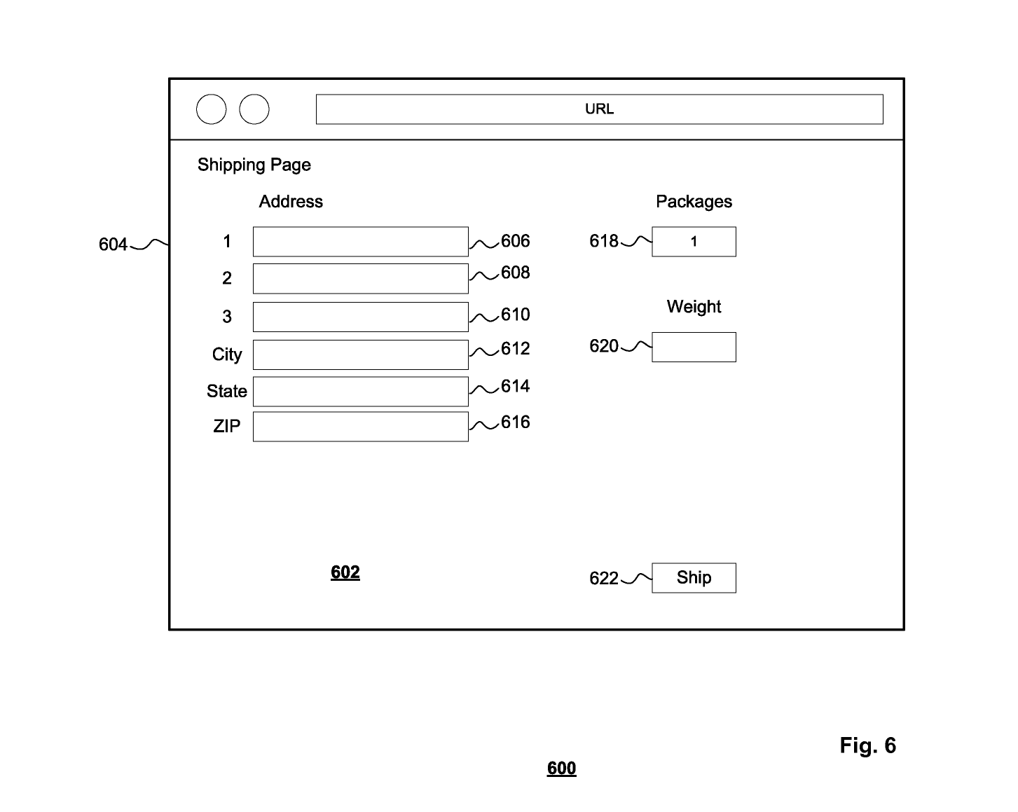

FIG. 6 shows a first view 600 of a rendered unmodified web-page, that is, pre-enrichment. The unmodified web-page represents an embodiment of the above described retrieved resource 210 and 410 such as, for example, the web-applications 210 and 410. More particularly, in the present embodiments, the above retrieved web resources 210 and 410 produce a rendered screen 602 within the browser 604, such as any of the above browsers, representing a Shipping Page, via which packages can be shipped. It can be appreciated that the screen 602 comprises unpopulated address fields 606 to 614. Additionally, a Packages field 618 is provided to allow the number of packages to be shipped to be entered. Furthermore, a Weight field 620 is provided to allow the total weight of the package or packages to be entered. Finally, a Ship button 622 is provided to instigate shipping, or at least to instigate, for example, creation of a label for the shipping.

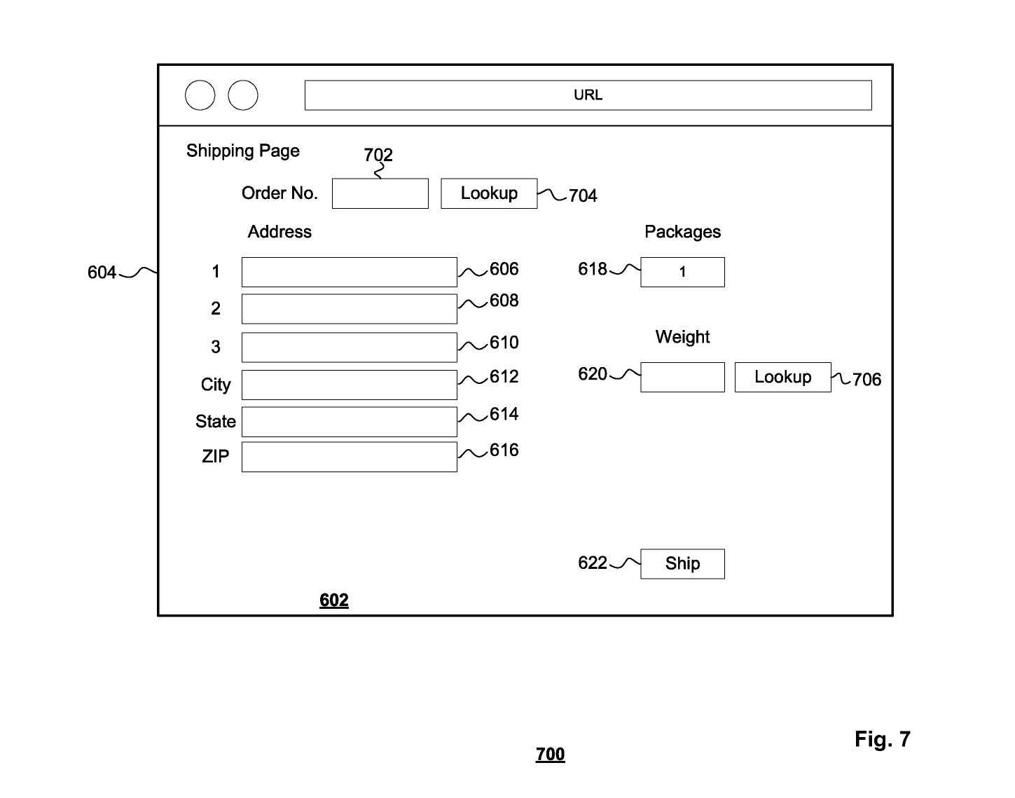

FIG. 7 illustrates a second view 700 of the rendered modified web-page, that is, a retrieved web page that has been augmented or otherwise enriched to access local data and to provide additional functionality. The reference numerals common to FIGS. 6 and 7 refer to corresponding features. It can be appreciated that the rendered screen 602 now comprises at least one additional feature. In the illustrated embodiment, an Order No field 702 has been inserted into the retrieved resource via the enrichment server described in GB1403896.2 as indicated in the above embodiments described with reference to at least FIGS. 1 to 5 and, in particular, FIGS. 4 and 5. A graphical icon 704 has also been inserted into the retrieved resource. In the illustrated embodiment, the graphical icon 704 is a look up button. The retrieved resource is also supplemented with additional functionality associated with the graphical icon 704. In the illustrated embodiment, that additional functionality takes the form of supplementary software that facilitates interactions with a messaging service, intermediary or other connector as described in the above embodiment with reference to FIGS. 1 to 5, to access local data. In the present example, invoking the Lookup button is arranged to send a request to the messaging service for address data corresponding to an order number entered in the Order No. field 702. Therefore, the modified retrieved resource will publish such a request for address data containing the Order No. entered into the Order No. field. It will be appreciated that his is predicated on the assumption that local data corresponding to that order number is available at, or otherwise accessible to, the messaging service. The retrieved resource is also supplemented with additional code to support receiving the requested local data and populating the relevant fields with the corresponding data. In the present embodiment, address details corresponding to the entered order number will be placed in the address fields 606 to 616.

Additionally, or alternatively, the retrieved resource has been or can be supplemented with functionality that supports retrieving local data from a local device. In preferred embodiments the local data is a weight measurement and the local device is a weighing scale as described above. Again, the supplementary functionality is arranged to use the messaging service to retrieve the weight measurement and to populate the weight field 620 in response to invoking a Lookup button 706. The Lookup button 706 has associated software that publishes a request for a weight measurement from a locally accessible weighing scale to the messaging service. The messaging service makes that request available to the driver 234 that, in turn, retrieves the current weight measurement from the weighing scales and published the weight measurement to the messaging service. The messaging service makes the published weight available to the retrieved resource. The Weight field 620 is populated with the weight measurement. The above exchange takes place using a commonly assigned channel as described in the above embodiments.

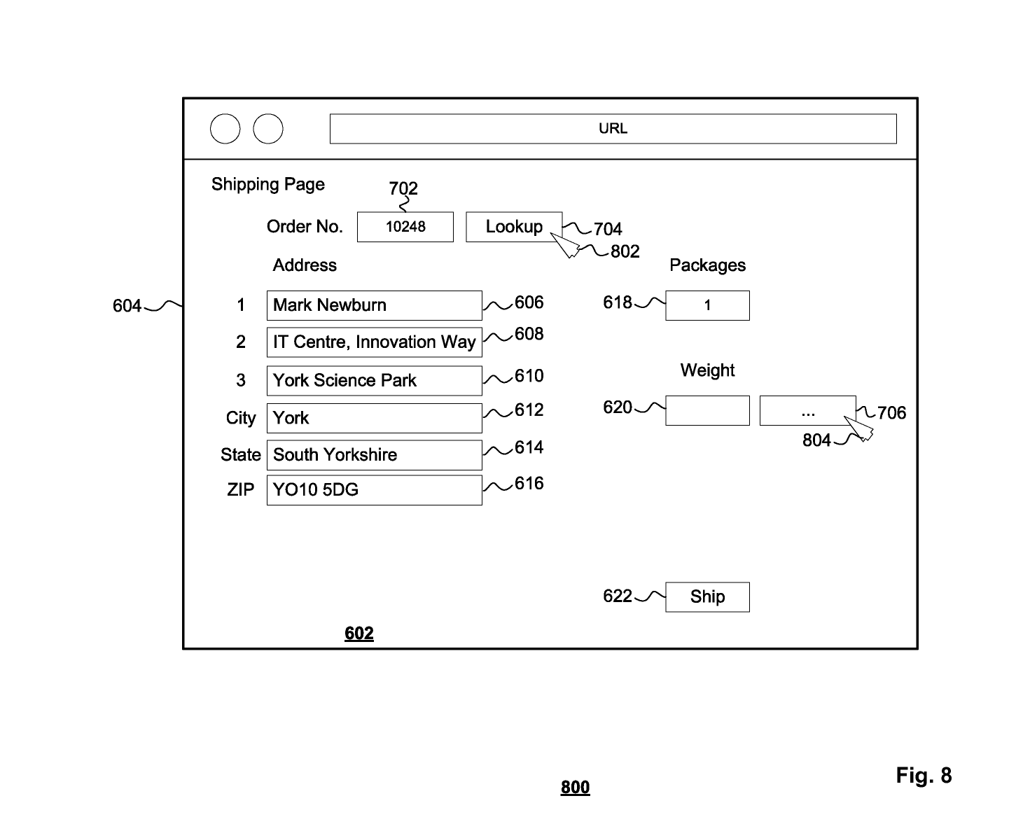

FIG. 8 depicts a third view 800 of the rendered modified web-page showing access to local data. It can be appreciated that an order no. 10248 has been entered into the order number field 702 and that the corresponding Lookup button 704 has been invoked, as illustrated by the pointer icon 802, with the result that the web application posted the order number 10248 to the messaging service in a request for corresponding address details and that the data base management system has processed the posted order number to retrieve the corresponding address details. It can be appreciated that the address details have been returned by the data base management system and used to populate respective address fields.

Additionally, it can be appreciated that the Weight Lookup button 706 has been invoked by a pointer 804.

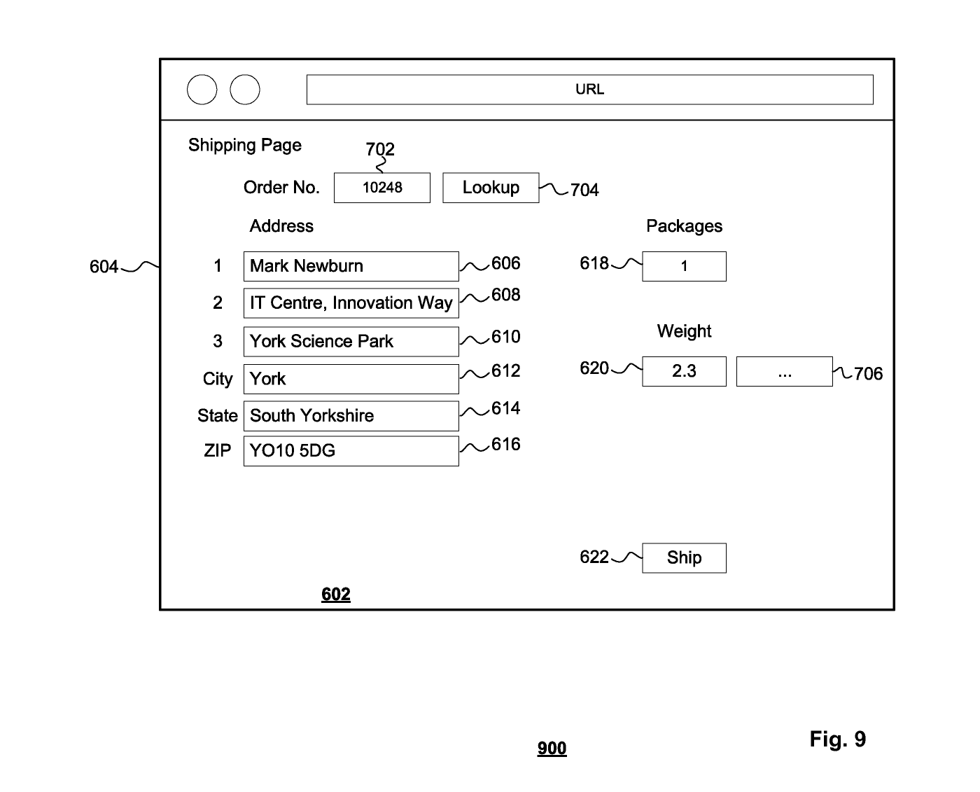

FIG. 9 shows a fourth view 900 of the rendered modified web-page populated with local data. It can be appreciated that the above described invoking of the Weight button 706 by the point 804 caused the modified web application to publish a request to the messaging service for a weight measurement from the locally accessible weighing scales. The messaging service, in turn, makes the published request available to the driver 234 for the weighing scales. The driver 234 causes the current weight measurement of the weighing scales to be published to the messaging service. The messaging service has made that weight measurement available to the web application, which has populated the Weight field 620 with the weight 2.3 kg.

Although the above embodiments have been described with reference to integrating local data into a web-application, that is, rendering local data accessible to the web-application or facilitating using the local data with a web-application, even though the local data is external to the restricted or constrained environment, embodiments are not limited thereto. Embodiments can be realised in which the local data is integrated in the same, or a like, manner with web-content other than a web-application.

Although the above embodiments have been described within a shipping context, at least insofar as concerns FIGS. 6 to 9, embodiments are not limited to that context. Embodiments of the present invention can be applied in other technical areas such as, for example, integrating financial applications or other integration contexts such as, for example, other data integration contexts.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide machine executable code for implementing a system, device or method as described herein or as claimed herein and machine readable storage storing such a program. Still further, such programs may be conveyed electronically via any medium such as a communication signal carried over a wired or wireless connection and embodiments suitably encompass the same.

1. A data processing method, the method comprising
a. Commissioning a machine comprising a browser, the browser representing or having a secure environment for controlling access to local data, to associate a first universal resource indicator, or protocol data, with an application for accessing the local data accessible to, or stored by, the machine such that invoking the first universal resource indicator executes the application; the local data being accessible to, or stored externally to, the secure environment.

2. The method as claimed in claim 1, wherein the application is configured to facilitate populating a retrieved resource or web-application, associated with a second URI, running via the browser within the secure environment, with the local data.

3. The method as claimed in claim 2, wherein the application is configured to facilitate populating the retrieved resource or a web-application, running via the browser within the secure environment, with at least one of address data of the local data or measurement data.

4. The method of claim 1, further comprising a web-application processor configured to process a request for access to a second URI comprising retrieving the retrieved resource or web-application associated with the second URI, retrieving supplementary data associated with the second URI and integrating the retrieved supplementary date into the retrieved resource or web-application; the first URI being associated with the supplementary data.

5. The method of claim 4, wherein the supplementary data associated with the second URI comprises at least an application modifying the functionality of the retrieved resource or web application.

6. The method of claim 1, further comprising establishing an association between the first URI and the application within an operating system of the machine.

7. A data processing method for a machine comprising a storage manager, to access or store local data, and further comprising a browser, the browser representing or having a secure computing environment for at least controlling access to the local data, a registry to associate a first universal resource indicator, or protocol data, with an application for accessing the local data accessible to, or stored by, the machine such that invoking the first universal resource indicator executes the application; the local data being accessible to, or stored externally to, the secure environment, the method comprising:
a. receiving via a browser the first URI, the first URI being associated with a resource or web-application accessible via a server;
b. retrieving the resource or web-application and accessing supplementary data for supplementing the resource or web-application;
c. rendering the retrieved resource or web-application augmented by the retrieved supplementary data;
d. accessing, in response to an invocation associated with the rendered supplementary data, the local data, and
e. processing the accessed local data with the web-application.

8. The method of claim 7, wherein the application is configured to facilitate populating the retrieved resource or the web-application, associated with a second URI, running via the browser within the secure computing environment, with the local data.

9. The method of claim 8, wherein the application is configured to facilitate populating the retrieved resource or the a web-application, running via the browser within the secure computing environment, with at least one of address data of the local data or local data associated with a locally accessible device.

10. The method of claim 7, further comprising a web-application processor configured to process a request for access to a second URI, the web-application processor being arranged to
a. retrieve a web-application associated with the second URI,
b. retrieve supplementary data associated with the second URI and
c. integrate the retrieved supplementary date into the retrieved resource or web application; the first URI being associated with the supplementary data.

11. The method of claim 10, wherein the supplementary data associated with the second URI comprises at least an application modifying the functionality of the retrieved resource or web application.

12. A data processing system comprising a machine comprising a browser, the browser representing or having a secure environment for controlling access to local data, the machine further comprising a processor adapted to
a. associate a first universal resource indicator, or protocol data, with an application for accessing the local data accessible to, or stored by, the machine such that invoking the first universal resource indicator executes the application; the local data being accessible to, or stored externally to, the secure environment.

13. The system of claim 12, wherein the application is configured to facilitate populating a retrieved resource or web-application, associated with a second URI, running via the browser within the secure environment, with the local data.

14. The system of claim 13, wherein the application is configured to facilitate populating the retrieved resource or a web-application, running via the browser within the secure environment, with at least one of address data of the local data or measurement data.

15. The system of claim 12, further comprising a web-application processor configured to process a request for access to a second URI comprising retrieving the retrieved resource or web-application associated with the second URI, retrieving supplementary data associated with the second URI and integrating the retrieved supplementary date into the retrieved resource or web-application; the first URI being associated with the supplementary data.

16. The system of claim 15, wherein the supplementary data associated with the second URI comprises at least an application modifying the functionality of the retrieved resource or web application.

17. A system of claim 12, further comprising a registry to establish an association between the first URI and the application within an operating system of the machine.

18. A data processing system for a machine comprising a storage manager, to access or store local data, and further comprising a browser, the browser representing or having a secure computing environment for at least controlling access to the local data, a registry to associate a first universal resource indicator, or protocol data, with an application for accessing the local data accessible to, or stored by, the machine such that invoking the first universal resource indicator executes the application; the local data being accessible to, or stored externally to, the secure environment, the system comprising a processor adapted to:
a. receive via a browser the first URI, the first URI being associated with a resource or web-application accessible via a server;
b. retrieve the resource or web-application and accessing supplementary data for supplementing the resource or web-application;
c. render the retrieved resource or web-application augmented by the retrieved supplementary data;
d. access, in response to an invocation associated with the rendered supplementary data, the local data, and
e. process the accessed local data with the web-application.

19. The system of claim 18, wherein the application is configured to facilitate populating the retrieved resource or the web-application, associated with a second URI, running via the browser within the secure computing environment, with the local data.

20. The system of claim 19, wherein the application is configured to facilitate populating the retrieved resource or the a web-application, running via the browser within the secure computing environment, with at least one of address data of the local data or local data associated with a locally accessible device.

21. The system of claim 18, further comprising a web-application processor configured to process a request for access to a second URI, the web-application processor being arranged to
a. retrieve a web-application associated with the second URI,
b. retrieve supplementary data associated with the second URI and
c. integrate the retrieved supplementary date into the retrieved resource or web application; the first URI being associated with the supplementary data.

22. The system of claim 21, wherein the supplementary data associated with the second URI comprises at least an application modifying the functionality of the retrieved resource or web application.

23. Machine-readable storage storing machine-executable code comprising instructions arranged when executed to implement a method of claim 1.
